(19) United States
(12) Patent Application Publication
(10) Pub. No.: US 2018/0375130 A1
(43) Pub. Date: Dec. 27, 2018

(54) APPARATUS AND METHOD FOR PREDICTING LIFE SPAN OF FUEL CELL, AND VEHICLE SYSTEM HAVING THE SAME

(71) Applicants: HYUNDAI MOTOR COMPANY, Seoul (KR); KIA MOTORS CORPORATION, Seoul (KR); Industry-University Cooperation Foundation Hanyang University, Seoul (KR)

(72) Inventors: Jung Yeon Byun, Seoul (KR); Dong Jo Oh, Yongin-si (KR); Jong Hyun Lee, Yongin-si (KR); Suk Joo Bae, Seoul (KR); Byeong Min Mun, Seoul (KR)

(21) Appl. No.: 15/831,031

(22) Filed: Dec. 4, 2017

(30) Foreign Application Priority Data
Jun. 21, 2017 (KR) 10-2017-0078415

(51) Int. Cl. H01M 8/04298; H01M 8/04537; G06F 17/50

(52) U.S. Cl. CPC H01M 8/04305; H01M 8/04559; G06F 2217/16; G06F 17/5009; H01M 2250/20; H01M 8/04589

(57) ABSTRACT

An apparatus for predicting a life span of a fuel cell includes a processor configured to collect and store a stack current and a stack voltage of a fuel cell stack, define prediction model equations based on stack currents and stack voltages stored at different time points, correct the prediction model equations based on constant change states of the defined prediction model equations, and generate a life span prediction model by using the corrected prediction model equations, and predict a stack current and a stack voltage of the fuel cell stack after a specific time period based on the generated life span prediction model.

### CROSS-REFERENCE TO RELATED APPLICATION

This application is based on and claims the benefit of priority to Korean Patent Application No. 10-2017-0078415, filed on Jun. 21, 2017, in the Korean Intellectual Property Office, the entire disclosure of which is incorporated herein by reference.

### TECHNICAL FIELD

The present disclosure relates to an apparatus and a method for predicting a life span of a fuel cell, and a vehicle system having the same.

### BACKGROUND

A voltage of a fuel cell stack varies according to a used current unlike a battery. Accordingly, performance of a fuel cell is generally expressed in a current-voltage (I-V) curve to represent electrical characteristics. Because the performance of the stack deteriorates with time, a current/voltage value that may show a specific output continuously varies.

Model equations of the performance of the fuel cell have been well identified theoretically, but it is not easy to predict deterioration of performance with time based on a theoretical equation because changes of the parameters used in the corresponding equation with time cannot be known.

Further, there have been tries for predicting a change of the performance of a stack according to time based on a theoretical equation, but the accuracy of the theoretical equation is very low.

### SUMMARY

The present disclosure is conceived to solve the above-described problems of the related art, and the present disclosure provides a fuel cell life span predicting apparatus that may easily predict a life span of a fuel cell stack by defining a prediction model equation for predicting an I-V curve that deteriorates according to time to characterize the performance of the fuel cell stack, a fuel cell life span predicting apparatus, and a vehicle system.

The technical objects of the present disclosure are not limited to the above-mentioned one, and the other unmentioned technical objects will become apparent to those skilled in the art from the following description.

In accordance with an aspect of the present disclosure, an apparatus for predicting a life span of a fuel cell includes a processor configured to: collect and store a stack current and a stack voltage of a fuel cell stack; define prediction model equations based on stack currents and stack voltages stored at different time points, correct the prediction model equations based on constant change states of the defined prediction model equations, and generate a life span prediction model by using the corrected prediction model equation; and predict a stack current and a stack voltage of the fuel cell stack after a specific time period based on the generated life span prediction model.

In accordance with another aspect of the present disclosure, a method for predicting a life span of a fuel cell includes steps of: collecting and storing, by a processor, a stack current and a stack voltage of a fuel cell stack, defining, by the processor, prediction model equations based on stack currents and stack voltages stored at different time points, correcting, by the processor, the prediction model equations based on constant change states of the defined prediction model equations, generating, by the processor, a life span prediction model by using the corrected prediction model equations, and predicting, by the processor, a stack current and a stack voltage of the fuel cell stack after a specific time period based on the generated life span prediction model.

In accordance with another aspect of the present disclosure, a vehicle system includes: a fuel cell stack; a fuel cell life span predicting apparatus including a processor configured to collect a stack current and a stack voltage of a fuel cell stack form the fuel cell stack and accumulate and store the collected stack current and stack voltage, define prediction model equations based on stack currents and stack voltages stored at different time points, correct the prediction model equations based on constant change states of the defined prediction model equations, and predict a stack current and a stack voltage of the fuel cell stack after a specific time period based on the generated life span prediction model by using the corrected model equation; and an input/output interface configured to output a life span prediction result of the fuel cell stack.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a vehicle system, to which a fuel cell life span predicting apparatus is applied, according to an embodiment of the present disclosure;

FIG. 2 is a block diagram illustrating a configuration of the fuel cell life span predicting apparatus according to an embodiment of the present disclosure;

FIGS. 3A-3D through 6 are views illustrating an operation of the fuel cell life span predicting apparatus according to an embodiment of the present disclosure;

FIGS. 7 to 8 are views illustrating operations of a fuel cell life span predicting method according to an embodiment of the present disclosure; and

FIG. 9 is a block diagram illustrating a computing system that executes the fuel cell life span predicting method according to an embodiment of the present disclosure

### DETAILED DESCRIPTION

Hereinafter, exemplary embodiments of the present disclosure will be described in detail with reference to the accompanying drawings. Throughout the specification, it is noted that the same or like reference numerals denote the same or like components even though they are provided in different drawings. Further, in the following description of the present disclosure, a detailed description of known functions and configurations incorporated herein will be omitted when it may make the subject matter of the present disclosure rather unclear.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

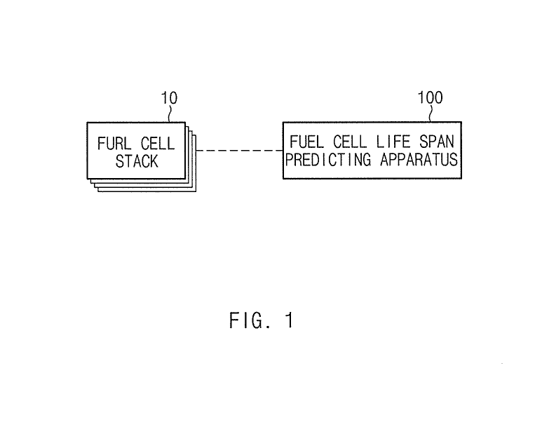

FIG. 1 is a view illustrating a vehicle system, to which a fuel cell life span predicting apparatus is applied, according to an embodiment of the present disclosure.

As illustrated in FIG. 1, the vehicle system according to the embodiment of the present disclosure may include a fuel cell stack 10 and a fuel cell life span predicting apparatus 100.

The fuel cell stack 10 provides power for driving a vehicle. Here, the fuel cell stack 10 may be constituted by repeatedly stacking a plurality of unit cells to couple the unit cells.

The fuel cell life span predicting apparatus 100 may collect and store information of the fuel cell stack 10, for example, information on a stack current I and a stack voltage V in real time or at a specific time cycle, and may generate a life span prediction model of the fuel cell stack 10 by using the stored stack current I and stack voltage V.

Then, the fuel cell life span predicting apparatus 100 may accumulate and store the stack current I and the stack voltage V, and may generate a life span prediction model of the fuel cell stack 10 based on the accumulated stack current I and stack voltage V.

Further, the fuel cell life span predicting apparatus 100 may predict a stack current and a stack voltage of the fuel cell stack 10 after a specific time period based on the generated life span prediction model of the fuel cell stack 10.

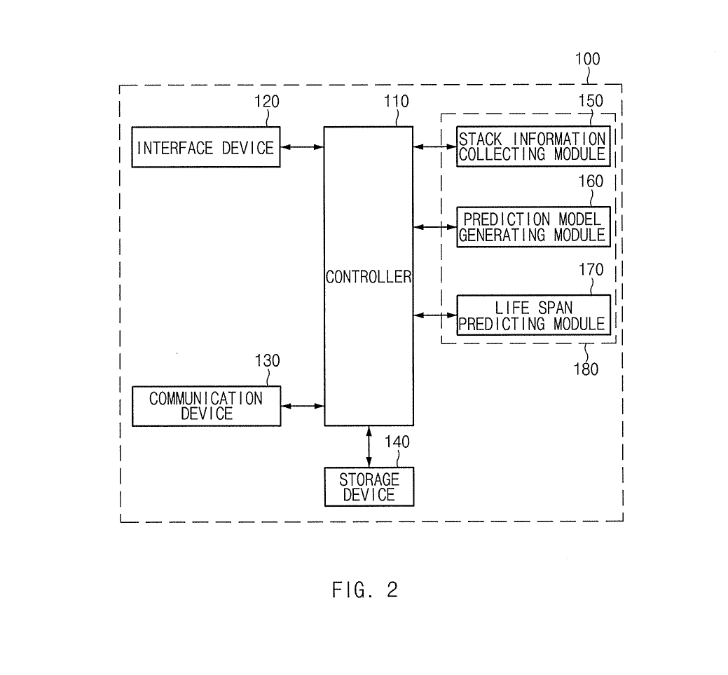

Accordingly, a detailed configuration of the fuel cell life span predicting apparatus 100 will be described with reference to the embodiment of FIG. 2.

The fuel cell life span predicting apparatus 100 according to the present disclosure may be embodied in the interior of the vehicle. Then, the apparatus 100 may be integrally formed with controllers in the interior of the vehicle, and may be embodied as a separate apparatus to be connected to the controllers of the vehicle by a separate connection unit. Here, the apparatus 100 may be operated in association with an engine and a motor of the vehicle, and may be operated in association with a controllers that controls an operation of the engine or the motor.

FIG. 2 is a block diagram illustrating a configuration of the fuel cell life span predicting apparatus according to an embodiment of the present disclosure.

Referring to FIG. 2, the fuel cell life span predicting apparatus 100 may include a controller 110, an interface device 120, a communication device 130, a storage device 140, and a processor 180 including a stack information collecting module 150, a prediction model generating module 160, and a life span predicting module 170. Here, the controller 110 may process signals delivered between the elements of the apparatus 100.

A processor 180 performs various functions of following modules 150, 160, and 170. The modules 150, 160, and 170 described below are implemented with software instructions executed on the processor 180.

The interface device 120 may include an input device that receives a control command from a user, and an output device that outputs an operation state and a result of the apparatus 100.

Here, the input device may include a key button, and may include a mouse, a joystick, a jog shuttle, and a stylus pen. Further, the input device may include a soft key that is embodied on a display.

The output device may include a display, and may include a voice output device such as a speaker. Then, when a touch sensor, such as a touch film, a touch sheet, and a touch pad, is provided in the display, the display may be operated as a touch screen, and may be embodied in a form in which an input device and an output device are integrated. Then, the display may include at least one of a liquid crystal display (LCD), a thin film transistor-liquid crystal display (TFT-LCD), an organic light-emitting diode (OLED), a flexible display, a field emission display (FED), and a 3D display.

The communication device 130 may include a communication module that supports a communication interface with electronic components and/or controllers provided in the vehicle. As an example, the communication module may be communication-connected to the fuel cell stack 10 (or a system that manages information of the fuel cell stack) of the vehicle to receive information on the stack current and the stack voltage of the fuel cell stack 10.

Here, the communication module may include a module that supports network communication of the vehicle, such as controller area network (CAN) communication, local interconnect network (LIN) communication, or Flex-Ray communication.

Further, the communication device 130 may include a communication module that supports a communication interface with an external device. As an example, the communication module may transmit a life span prediction result of the fuel cell stack 10 of the vehicle to a vehicle management system that manages a state of the vehicle.

Then, the communication module may include a module for wireless internet connection or a module for short range communication. Here, the wireless internet technology may include wireless LAN (WLAN), wireless broadband (WiBro), Wi-Fi, or world interoperability for microwave access (WiMax), and the short range communication technology may include Bluetooth, ZigBee, ultra-wideband (UWB), radio frequency identification (RFID), and infrared data association (IrDA).

The storage device 140 may store data and/or algorithms that are necessary for operating the fuel cell life span predicting apparatus 100.

As an example, the storage device 140 may store information of a stack current and a stack voltage of the fuel cell stack 10 received through the communication device 130. Further, the storage device 140 may store a command and/or an algorithm for generating a life span prediction model, and may store a life span prediction model generated based on the accumulated stack current and stack voltage.

Further, the storage device 140 may store a command and/or an algorithm for predicting a life span of the fuel cell stack 10, and may store a life span prediction result of the fuel cell stack 10 using a life span prediction model.

Here, the storage device 140 may include storage media, such as a random access memory (RAM), a static random access memory (SRAM), a read-only memory (ROM), a programmable read-only memory (PROM), and an electrically erasable programmable read-only memory (EEPROM).

The stack information collecting module 150 collects a stack current I and a stack voltage V of the fuel cell stack 10 and stores the collected stack current I and stack voltage V in the storage device 140. The stack information collecting module 150 may collect stack currents and stack voltages from the fuel cell stack 10 in real time, at a specific time cycle, and at times that are determined in advance.

Here, if a stack current and a stack voltage stored in advance exist when the collected stack current and stack voltage are stored in the storage device 140, the stack information collecting module 150 accumulates and stores the collected stack current and stack voltage in the stack current and the stack voltage stored in advance.

The prediction model generating module 160 extracts the stack current and the stack voltage accumulated for a specific time period, and defines an I-V based prediction model equation of the fuel cell stack 10 based on an I-V curve of the extracted stack current and stack voltage. The I-V based prediction model equation may be defined as in Equation 1.

V=ϕ₁×exp[−exp(ϕ₂)×I]+ϕ₃×exp[−exp(ϕ₄)×I] [Equation 1]

(in Equation 1, V is an accumulated stack voltage, I is an accumulated stack current, and φ1 to φ4 are arbitrary constants).

Here, the prediction model generating module 160 may define an I-V based prediction model equation by using a stack current and a stack voltage accumulated at a corresponding time point whenever an event for defining an IV-based prediction model equation of the fuel cell stack 10 is generated, and may store the defined I-V based prediction model equation in the storage device 140. Accordingly, the storage device 140 may store a plurality of I-V based prediction model equation, which are defined by using stack currents and stack voltages at different time points. Then, the plurality of I-V based prediction model equations may be stored such that time information may be matched.

The event for defining an I-V based prediction model equation of the fuel cell stack 10 may be generated at a specific cycle, and may be generated when a specific time point is reached or by an input signal of the user.

As an example, the prediction model generating module 160 may define an I-V based prediction model by using stack currents and stack voltages accumulated at corresponding time points at a specific cycle, and may define an I-V based prediction model equation by using the stack current and the stack voltage accumulated at an arbitrarily determined time point or at a time point when an input signal of the user is received.

In this way, the prediction model generating module 160 identifies change states of φ1 to φ4 according to a change of time with reference to a plurality of I-V based prediction model equations. The change states of φ1 to φ4 according to a change of time may be represented as in Table 1.

TABLE 1

| [symbol] | Ø1 | Ø2 | Ø3 | Ø4 |
|---|---|---|---|---|
| 0 | 0.183 | −2.299 | 0.815 | −7.165 |
| 91 | 0.185 | −2.239 | 0.811 | −7.112 |
| 166 | 0.184 | −2.213 | 0.811 | −7.075 |
| 302 | 0.186 | −2.202 | 0.809 | −7.074 |
| 420 | 0.186 | −2.176 | 0.808 | −7.047 |
| 557 | 0.186 | −2.126 | 0.806 | −6.993 |
| 606 | 0.187 | −2.102 | 0.804 | −6.970 |
| 754 | 0.184 | −2.020 | 0.804 | −6.866 |
| 920 | 0.186 | −2.058 | 0.803 | −6.920 |
| 1110 | 0.185 | −1.977 | 0.802 | −6.820 |
| 1249 | 0.186 | −2.034 | 0.803 | −6.892 |
| 1415 | 0.186 | −2.007 | 0.802 | −6.861 |
| 1605 | 0.185 | −1.979 | 0.801 | −6.828 |
| 1773 | 0.183 | −1.878 | 0.800 | −6.704 |
| 1941 | 0.184 | −1.908 | 0.800 | −6.741 |
| 2107 | 0.185 | −1.912 | 0.799 | −6.7S1 |
| . | . | . | . | . |
| . | . | . | . | . |
| . | . | . | . | . |

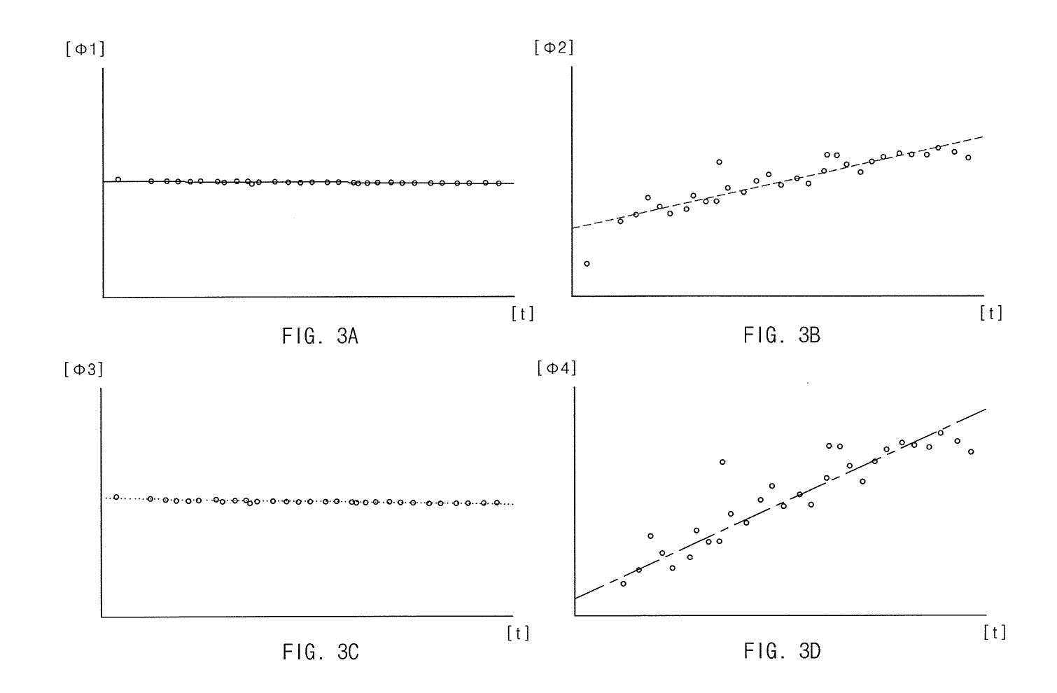

In Table 1, φ1 to φ4 are arbitrary constants of the I-V based prediction model equation defined at an arbitrary time, and are indicated by 3 digits after the decimal point. The change states of φ1 to φ4 according to a change of time may be represented as in the graphs of FIGS. 3A-3D based on Table 1.

FIG. 3A is a graph depicting a change of φ1 according to a change of time, FIG. 3B is a graph depicting a change of φ2 according to a change of time, FIG. 3C is a graph depicting a change of φ3 according to a change of time, and FIG. 3D is a graph depicting a change of φ4 according to a change of time.

Referring to the graphs of FIGS. 3A-3D, it can be identified that φ1 and φ3 hardly change as the second digits after the decimal point change according to a change of time, whereas φ2 and φ4 gradually increase at a specific inclination according to a change of time.

As an example, the change state of φ2 according to a change of time may be represented by a linear function such as ‘a1+a2t’, and the change state of φ4 according to a change of time may be represented by a linear function such as ‘b1+b2t’.

Accordingly, the prediction model generating module 160 may correct the change states of φ2 and φ4 illustrated in the graphs of FIGS. 3A-3D by reflecting the I-V based prediction model equation of Equation 1 on the change states of φ2 and φ4. The corrected I-V based prediction model equation may be defined as in Equation 2.

V=ϕ₁×exp[−exp(a₁+a₂t)×I]+ϕ₃×exp[−exp(b₁+b₂t)×I] [Equation 2]

(In Equation 2, a1 is an initial value of φ2, a2 is a change rate of φ2 according to time, b1 is an initial value of φ4, and b2 is a change rate of φ4 according to time).

The prediction model generating module 160 generates a life span prediction model based on the I-V based prediction model equation corrected as in Equation 2, and stores the generated life span prediction model in the storage device 140.

The life span prediction module 170 calls the life span prediction model stored in the storage device 140 if a specific condition is satisfied or a life span prediction event is generated by an input signal of the user.

The life span predicting module 170 may predict a life span of a fuel cell by applying time information T for predicting a life span of the fuel cell stack 10 to the called life span prediction model to identify a stack current and a stack voltage after time T.

The life span predicting module 170 may store a life span prediction result of the fuel cell in the storage device 140. Further, the life span predicting module 170 may transmit a life span prediction result of the fuel cell to an internal or external vehicle management system through the communication device 130.

Accordingly, the vehicle management system may recognize an AS time point of the corresponding vehicle based on the life span prediction result of the fuel cell in advance, and may guide the recognized AS time point to the user.

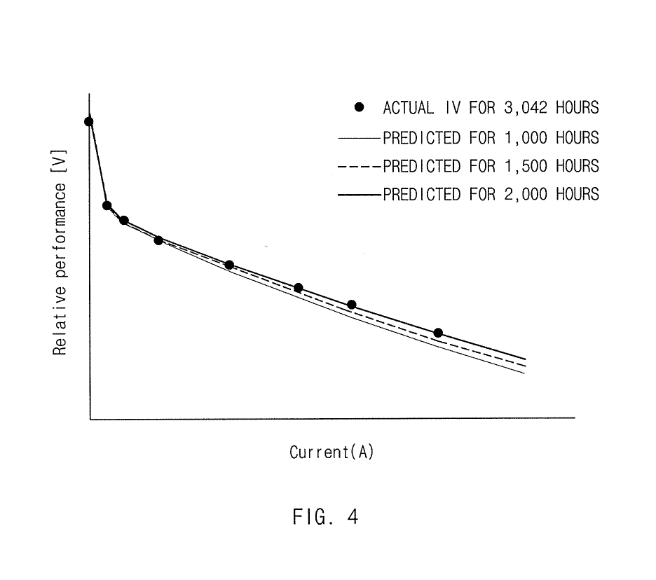

FIGS. 4 to 6 illustrate evaluation graphs of a life span prediction result for the fuel cell life span predicting apparatus according to the embodiment of the present disclosure.

FIG. 4 is a graph that compares a result obtained by predicting a life span of the fuel cell stack 10 corresponding to 3042 hours by using performance data of the fuel cell stack 10 for 1000 hours, 1500 hours, and 2000 hours, and performance data of the fuel cell stack 10 for an actual 3042 hours.

As illustrated in FIG. 4, it may be identified that prediction errors of the life span prediction results for 1000 hours, 1500 hours, and 2000 hours using the performance data of the fuel cell stack 10 decrease as a prediction time point reaches an actual measurement time point but the prediction error of the life span prediction result using the performance data of the fuel cell stack 10 to 1500 hours may be predicted to an error range, for example, of 0.015.

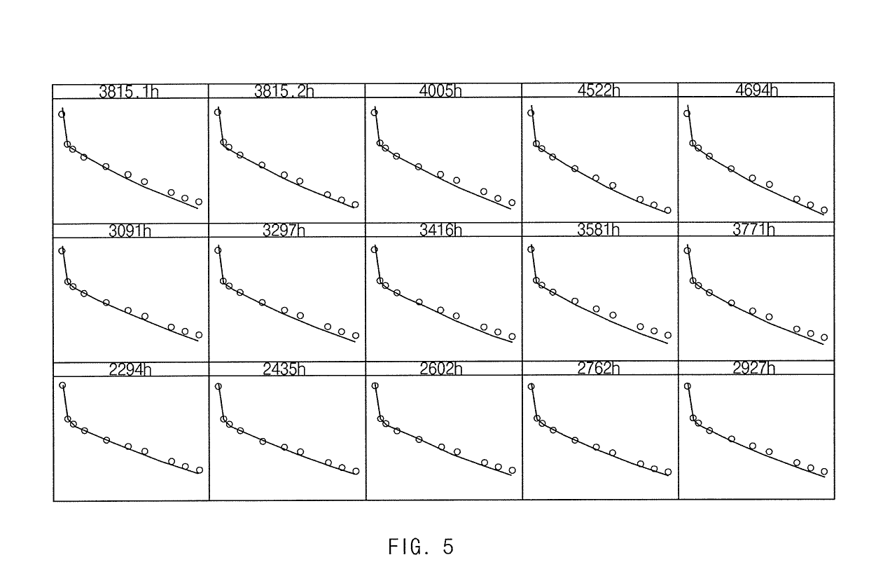

FIG. 5 is a graph that compares a result obtained by predicting a life span of the fuel cell stack 10 corresponding to 2294 to 4694 hours by using performance data of the fuel cell stack 10 to 2000 hours, and the actually measured performance data of the fuel cell stack 10. In FIG. 5, the solid line indicates a life span prediction result of the fuel cell stack 10 and the dots indicate the actually measured performance data.

As illustrated in FIG. 5, an average error range of the life span prediction results of the fuel cell stack 10 for hours from the actually measured performance data is 0.0199 and it may be identified that the life span prediction result is similar to the actually measured performance data.

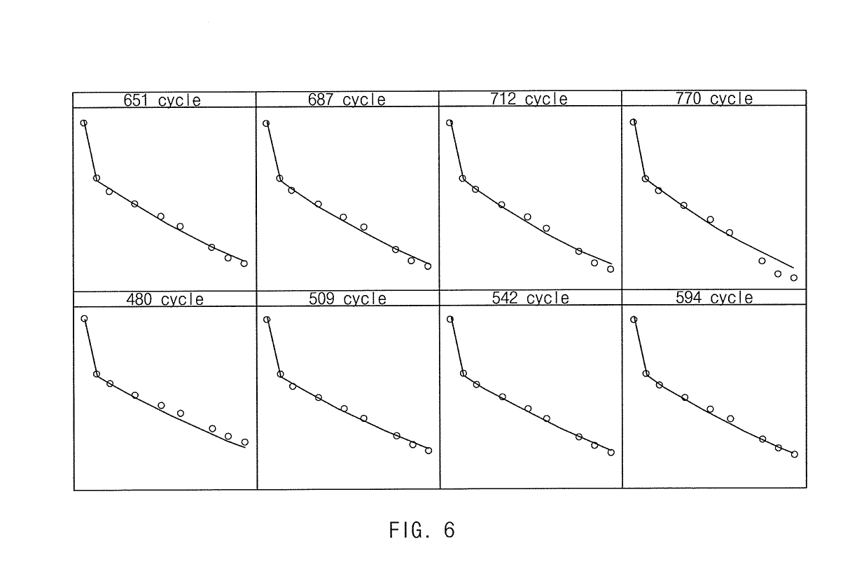

FIG. 6 is a graph that compares a result obtained by predicting a life span of the fuel cell stack 10 corresponding to 480 to 770 cycles by using performance data of the fuel cell stack 10 to 297 cycles, and the actually measured performance data of the fuel cell stack 10. In FIG. 6, the solid line indicates a life span prediction result of the fuel cell stack and the dots indicate the actually measured performance data.

As illustrated in FIG. 6, an average error range of the life span prediction results of the fuel cell stack 10 for cycles from the actually measured performance data is 0.0148 and it may be identified that the life span prediction result is similar to the actually measured performance data.

An operational flow of the fuel cell life span predicting apparatus according to an embodiment of the present disclosure will be described in detail.

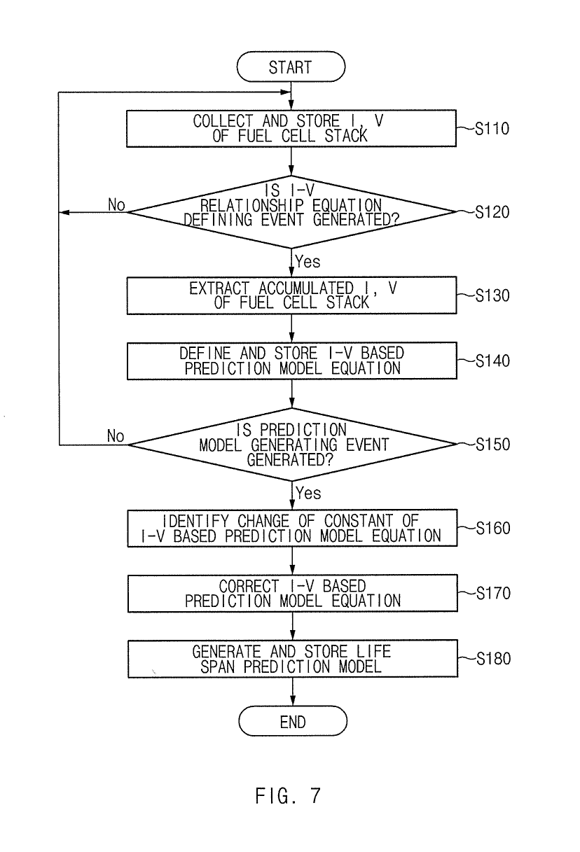

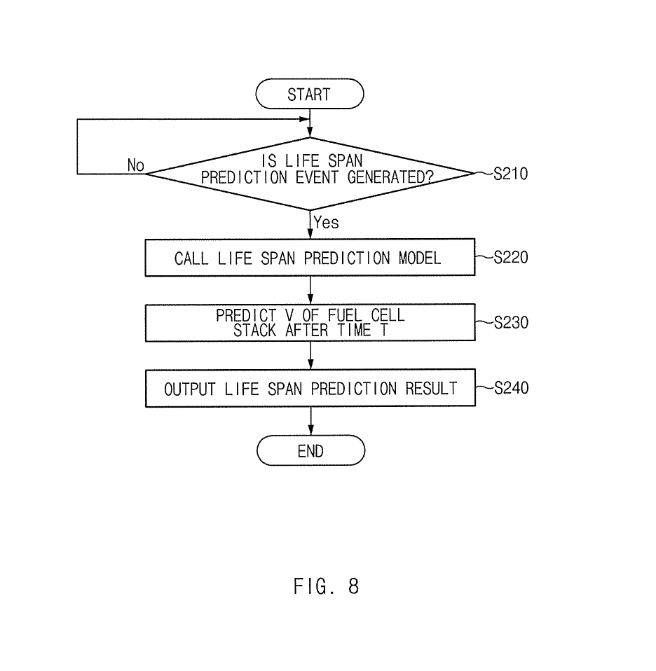

FIGS. 7 to 8 are views illustrating operations of a fuel cell life span predicting method according to an embodiment of the present disclosure.

Referring to FIG. 7, the fuel cell life span predicting apparatus 100 collect and stores a stack current I and a stack voltage V of the fuel cell stack 10 (S110). In process S110, the fuel cell life span predicting apparatus 10 may collect a stack current I and a stack voltage V in real time, at a specific time cycle, or at an arbitrary irregular time. Then, the fuel cell life span predicting apparatus 100 accumulate and store the collected stack current I and stack voltage V in a value stored in advance.

Thereafter, if an event for defining an I-V based prediction model equation of the fuel cell stack 10 is generated (S120), the fuel cell life span predicting apparatus 100 extracts the stack current I and the stack voltage V of the fuel cell stack 10 accumulated and stored in process S110 (S130). The fuel cell life span predicting apparatus 10 defines and stores an I-V based prediction model equation based on the stack current I extracted in process S130 and the I-V curve of the stack voltage V (S140). The defined I-V based prediction model equation is referenced by Equation 1.

Processes S110 to S140 may be repeated until an event for generating a life span prediction model for the fuel cell stack 10 is generated. Accordingly, a plurality of I-V based prediction model equations may be defined in process S140.

If an event for generating a life span prediction model for the fuel cell stack 10 is generated (S150), the change state of the constants are identified by extracting the plurality of I-V based prediction model equation stored in process S140 (S160).

Accordingly, the fuel cell life span predicting apparatus corrects the I-V based prediction model equation based on the constant change state identified in process S160 (S170). The corrected I-V based prediction model equation is referenced by Equation 2.

Thereafter, the fuel cell life span predicting apparatus 100 generates and stores a life span prediction model based on the I-V based prediction model equation corrected in process S170 (S180).

The life span prediction model stored in process S180 may be utilized to predict a life span of the fuel cell later.

FIG. 8 illustrates a life span prediction model generating process according to an embodiment of the present disclosure. Referring to FIG. 8, if a life span prediction event for the fuel cell stack 10 is generated (S210), the fuel cell life span predicting apparatus 100 calls the life span prediction model stored in process S180 of FIG. 7 (S220).

Thereafter, the fuel cell life span predicting apparatus 100 may predict a life span of the fuel cell by inputting a life span prediction time Tb and the accumulated stack voltage I to the life span prediction model and identifying the stack current and the stack voltage of the fuel cell stack 10 after time period T (S230).

The fuel cell life span predicting apparatus 100 outputs the life span prediction result of process S230 (S240). Then, the fuel cell life span predicting apparatus 100 may display a life span prediction result on a display screen in the vehicle, and may transmit a life span prediction result to an external vehicle management system.

The fuel cell life span predicting apparatus 100 according to the embodiment, which is operated as mentioned above, may be realized in a focal of a memory and a hardware device including a process that processes operations, and may be driven in a form in which the fuel cell life span predicting apparatus 100 is included in another hardware device, such as a microprocessor or a general-purpose computer system. Further, the controller 110, the selected information collecting device 150, the prediction model generating module 160, and the life span predicting module 170 of the fuel cell life span predicting apparatus 100 according to the embodiment may be realized by one or more processors.

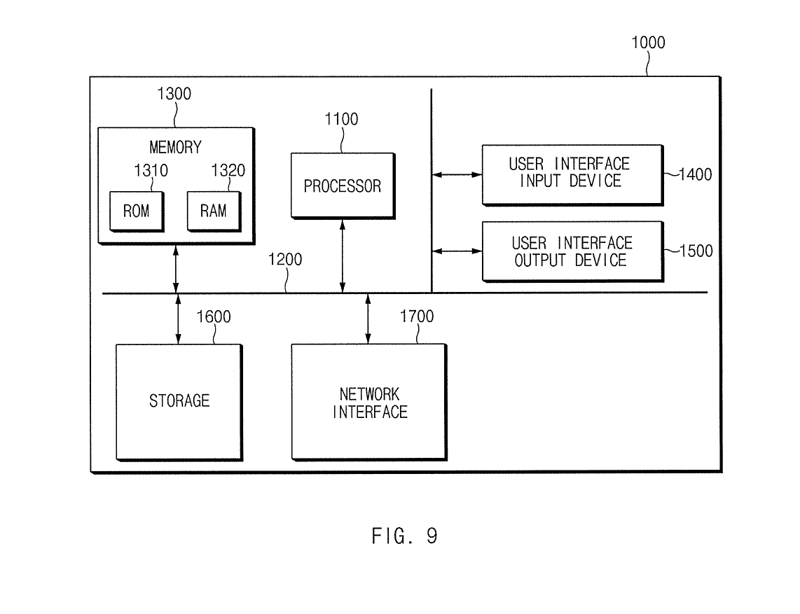

FIG. 9 is a block diagram illustrating a computing system that executes the method according to an embodiment of the present disclosure.

Referring to FIG. 9, the computing system 1000 may include at least one processor 1100 connected through a bus 1200, a memory 1300, a user interface input device 1400, a user interface output device 1500, a storage 1600, and a network interface 1700.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the steps of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM memory, a flash memory, a ROM memory, an EPROM memory, an EEPROM memory, a register, a hard disk, a detachable disk, or a CD-ROM. The exemplary storage medium is coupled to the processor 1100, and the processor 1100 may read information from the storage medium and may write information in the storage medium In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the present disclosure, a life span of the fuel cell stack may be accurately predicted by defining a prediction model equation for predicting an I-V curve that deteriorates according to time to characterize a performance of the fuel cell stack.

The above description is a simple exemplification of the technical spirit of the present disclosure, and the present disclosure may be variously corrected and modified by those skilled in the art to which the present disclosure pertains without departing from the essential features of the present disclosure.

Therefore, the disclosed embodiments of the present disclosure do not limit the technical spirit of the present disclosure but are illustrative, and the scope of the technical spirit of the present disclosure is not limited by the embodiments of the present disclosure. The scope of the present disclosure should be construed by the claims, and it will be understood that all the technical spirits within the equivalent range fall within the scope of the present disclosure.

What is claimed is:

1. An apparatus for predicting a life span of a fuel cell, the apparatus comprising a processor configured to:
collect and store a stack current and a stack voltage of a fuel cell stack;
define prediction model equations based on stack currents and stack voltages stored at different time points, correct the prediction model equations based on constant change states of the defined prediction model equations, and generate a life span prediction model by using the corrected prediction model equations; and
predict a stack current and a stack voltage of the fuel cell stack after a specific time period based on the generated life span prediction model.

2. The apparatus of claim 1, wherein the processor accumulates and stores the collected stack current and stack voltage in a stack current and a stack voltage, which have been stored in advance.

3. The apparatus of claim 2, wherein the processor defines the prediction model equations based on a relationship curve of the stack current and stack voltage accumulated at a specific event generation time point.

4. The apparatus of claim 3, wherein the processor defines a prediction model equation as in the following equation:
V=ϕ₁×exp[−exp(ϕ₂)×I]+ϕ₃×exp[−exp(ϕ₄)×I] [Equation]
(Here, V is an accumulated stack voltage, I is an accumulated stack current, and φ1 to φ4 are arbitrary constants).

5. The apparatus of claim 4, wherein the arbitrary constants φ1 and φ3 of the prediction model equation are values, of which changes according to a change of time are within an error range, and
wherein the arbitrary constants φ2 and φ4 of the prediction model equation are values, which increase at specific change rates according to a change of time.

6. The apparatus of claim 5, wherein the processor corrects the prediction model equation by reflecting change states of the arbitrary constants φ2 and φ4 on the prediction model equation.

7. The apparatus of claim 6, wherein the processor corrects the prediction model equation as in the following equation:
V=ϕ₁×exp[−exp(a₁+a₂t)×I]+ϕ₃×exp[−exp(b₁+b₂t)×I] [Equation]
(here, a1 is an initial value of φ2, a2 is a change rate of φ2 according to time, b1 is an initial value of φ4, and b2 is a change rate of φ4 according to time).

8. The apparatus of claim 1, wherein the processor collects a stack current and a stack voltage from the fuel cell stack at a specific time cycle.

9. The apparatus of claim 1, wherein the processor collects a stack current and a stack voltage from the fuel cell stack at times, which are irregularly determined in advance.

10. A method for predicting a life span of a fuel cell, the method comprising steps of:
collecting and storing, by a processor, a stack current and a stack voltage of a fuel cell stack;
defining, by the processor, prediction model equations based on stack currents and stack voltages stored at different time points;
correcting, by the processor, the prediction model equations based on constant change states of the defined prediction model equations;
generating, by the processor, a life span prediction model by using the corrected prediction model equations; and
predicting, by the processor, a stack current and a stack voltage of the fuel cell stack after a specific time period based on the generated life span prediction model.

11. The method of claim 10, wherein the step of storing a stack current and a stack voltage includes:
accumulating and storing the collected stack current and stack voltage in a stack current and a stack voltage, which have been stored in advance.

12. The method of claim 11, wherein the step of defining prediction model equations includes:
defining the prediction model equation based on a relationship curve of the stack current and stack voltage accumulated at a specific event generation time point.

13. The method of claim 12, wherein the step of defining prediction model equations includes:
defining a prediction model equation as in the following equation:
V=ϕ₁×exp[−exp(ϕ₂)×I]+ϕ₃×exp[−exp(ϕ₄)×I] [Equation]
(Here, V is an accumulated stack voltage, I is an accumulated stack current, and φ1 to φ4 are arbitrary constants).

14. The method of claim 13, wherein the arbitrary constants φ1 and φ3 of the prediction model equation are values, of which changes according to a change of time, are within an error range, and
wherein the arbitrary constants φ2 and φ4 of the prediction model equation are values, which increase at specific change rates according to a change of time.

15. The method of claim 14, wherein the step of correcting the prediction model equations includes:
correcting the prediction model equation by reflecting change states of the arbitrary constants φ2 and φ4 on the prediction model equation.

16. The method of claim 15, wherein the step of correcting the prediction model equations includes:
correcting the prediction model equation as in the following equation:
V=ϕ₁×exp[−exp(a₁+a₂t)×I]+ϕ₃×exp[−exp(b₁+b₂t)×I] [Equation]
(here, a1 is an initial value of φ2, a2 is a change rate of φ2 according to time, b1 is an initial value of φ4, and b2 is a change rate of φ4 according to time).

17. The method of claim 10, wherein the step of storing a stack current and a stack voltage includes:
collecting a stack current and a stack voltage from the fuel cell stack at a specific time cycle.

18. The method of claim 10, wherein the step of storing a stack current and a stack voltage includes:
collecting a stack current and a stack voltage from the fuel cell stack at times, which are irregularly determined in advance.

19. A vehicle system comprising:
a fuel cell stack;
a fuel cell life span predicting apparatus including a processor configured to collect a stack current and a stack voltage of a fuel cell stack form the fuel cell stack, accumulate and store the collected stack current and stack voltage, define prediction model equations based on stack currents and stack voltages stored at different time points, correct the prediction model equations based on constant change states of the defined prediction model equations, and predict a stack current and a stack voltage of the fuel cell stack after a specific time period based on the generated life span prediction model by using the corrected model equation; and
an input/output interface, communicatively connected to the processor, configured to output a life span prediction result of the fuel cell stack.

20. The vehicle system of claim 19, wherein the processor defines the prediction model equations based on a relationship curve of the stack current and stack voltage accumulated at a specific event generation time point.
